(19) United States
(12) Patent Application Publication
(10) Pub. No.: US 2017/0051710 A1
(43) Pub. Date: Feb. 23, 2017

(54) BURNER AND FUEL VAPORIZING DEVICE

(71) Applicant: HINO MOTORS, LTD., Hino-shi, Tokyo (JP)

(72) Inventors: Ryo Shibuya, Hino-shi (JP); Ichiro Tsumagari, Hino-shi (JP)

(21) Appl. No.: 15/305,927

(22) PCT Filed: May 28, 2015
(86) PCT No.: PCT/JP2015/065372

§ 371 Date: Oct. 21, 2016

(30) Foreign Application Priority Data
May 28, 2014 (JP) 2014-110003

(51) Int. Cl. F02M 31/18; F02M 37/00; F02M 31/125

(52) U.S. Cl. CPC F02M 31/183; F02M 31/125; F02M 37/0064

(57) ABSTRACT

A burner (20) includes a combustion unit (21), a fuel supply unit (22), a vaporizer (30), an air supply unit (45), and a control unit (50). The fuel supply unit (22) supplies fuel to the combustion unit (21). The vaporizer (30) uses an electric heater (32) to heat and vaporize fuel supplied from the fuel supply unit (22) to the combustion unit (21). The air supply unit (45) supplies air to the vaporizer (30). The control unit (50) controls the supply of fuel from the fuel supply unit (22), the supply of electrical power to the electric heater (32), and the supply of air from the air supply unit (45). The control unit (50) causes the air supply unit (45) to supply air while the supply of fuel from the fuel supply unit (22) is stopped. The control unit (50) supplies electrical power to the electric heater (32) and controls the temperature of the electric heater (32) so as to reach a combustible temperature at which fuel can combust.

### TECHNICAL FIELD

The present invention relates to a burner having a vaporizer that vaporizes fuel and to a fuel vaporizing device that vaporizes fuel.

### BACKGROUND ART

Conventionally, diesel particulate filters (DPFs), which capture particulate matter (PM) contained in exhaust gas, are arranged in the exhaust passages of diesel engines. In such a DPF, in order to maintain the function of capturing particulate matter, a regeneration process of burning particulate matter captured by the DPF using exhaust gas is performed.

For example, Patent Document 1 discloses a regeneration process, in which a mixture of fuel and air in a burner arranged upstream of a DPF is combusted to generate combusted gas and the generated combusted gas is supplied to the exhaust passage to increase the temperature of exhaust gas flowing into the DPF.

As a burner that supplies combusted gas to an exhaust passage, a burner is also known in which fuel is vaporized in advance by a vaporizer having an electric heater that heats fuel to generate an air-fuel mixture using the vaporized fuel.

### PRIOR ART DOCUMENT

### Patent Document

Patent Document 1: Japanese Laid-Open Patent Publication No. 2011-185493

### SUMMARY OF THE INVENTION

### Problem that the Invention is to Solve

In a vaporizer, a constituent that is not vaporized during vaporization of fuel is deteriorated to form deposits. When such deposits are accumulated, the flow path in the vaporizer is narrowed to decrease heat transfer performance of the electric heater to fuel. Such accumulation of deposits is not limited to vaporizers using electric heaters, but is common in vaporizers that vaporize fuel.

It is an objective of the present invention to provide a burner and a fuel vaporizing device that are capable of restraining accumulation of deposits in a vaporizer that vaporizes fuel.

### Means for Solving the Problems

To achieve the above objective, a burner includes a combustion section including a combustion chamber in which fuel is combusted, a fuel supply section that supplies fuel, a vaporizer that supplies vaporized fuel to the combustion chamber, the vaporized fuel being a fuel vaporized by heating fuel supplied from the fuel supply section with a heating section, an air supply section that supplies air to the vaporizer, and a control unit that controls supply of fuel by the fuel supply section, heating of the heating section, and supply of air by the air supply section. The control unit performs supply of air by the air supply section and heating of the heating section while supply of fuel by the fuel supply section is stopped, and creates, in an air atmosphere, a state in which a temperature of the heating section is greater than or equal to a combustible temperature at which fuel is combustible.

To achieve the above objective, a fuel vaporizing device includes a fuel supply section that supplies fuel to a combustion section including a combustion chamber in which fuel is combusted, a vaporizer that supplies vaporized fuel to the combustion chamber, the vaporized fuel being a fuel vaporized by heating fuel supplied from the fuel supply section with a heating section, an air supply section that supplies air to the vaporizer, and a control unit that controls supply of fuel by the fuel supply section, heating of the heating section, and supply of air by the air supply section. The control unit performs supply of air by the air supply section and heating of the heating section in a state in which supply of fuel by the fuel supply section is stopped and creates, in an air atmosphere, a state in which a temperature of the heating section is greater than or equal to a combustible temperature at which fuel is combustible.

According to the above configurations, in a state in which supply of fuel is stopped, supply of air to the vaporizer and heating of the heating section are performed. With this, while the interior space of the vaporizer is left in an air atmosphere, i.e., in an oxygen atmosphere, the temperature of the heating section is controlled to be a combustible temperature. As a result, deposits in the vaporizer are allowed to be combusted. Thus, accumulation of deposits in the vaporizer is restrained.

In the burner, preferably the air supply section includes an air passage that leads to a portion located downstream of a compressor, which constitutes a forced induction device, in an intake passage of an engine, and an air valve that opens/closes the air passage. The control unit supplies air to the vaporizer by controlling the air valve to be in an open state and stops supply of air to the vaporizer by controlling the air valve to be in a closed state.

According to the above configuration, one compressor can have two functions. One is a function that compresses intake air of the engine, and the other is a function that compresses air supplied to the vaporizer. Thus, the configuration to increase the pressure of air supplied to the vaporizer is simplified.

Preferably, the burner further includes a combustion air supply section that supplies air to the combustion section. The combustion air supply section includes a combustion air passage that connects the combustion section with the intake passage and a combustion air valve that opens/closes the combustion air passage. The air passage is branched off from a portion of the combustion air passage that is located upstream of the combustion air valve.

According to the above configuration, air used for combustion of fuel and air used for combustion of deposits flow through the combustion air passage in common. Thus, the configuration to supply air to the combustion section and the vaporizer is simplified.

In the burner, preferably the heating section is an electric heater, and immediately after supply of fuel by the fuel supply section is finished, the control unit creates, in an air atmosphere, a state in which a temperature of the electric heater is greater than or equal to the combustible temperature, at which fuel is combustible.

The above configuration allows fuel that remains in the vaporizer to be combusted immediately after supply of fuel to the combustion section is finished, i.e., before the fuel that remains in the vaporizer is deteriorated. This restrains generation of deposits itself.

In the burner, preferably the heating section is an electric heater, and the control unit starts supply of fuel by the fuel supply section after creating, in an air atmosphere, a state in which a temperature of the electric heater is greater than or equal to the combustible temperature, at which fuel is combustible.

According to the above configuration, after removal of deposits is performed, supply of fuel to the combustion section is started. This allows fuel to be efficiently vaporized.

In the burner, the vaporizer may be configured by a partition member that partitions the combustion chamber. The heating section may be a heat exchanging section that vaporizes fuel flowing through a flow path formed by the partition member with combustion heat of the combustion chamber. The fuel supply section may include a first fuel supply section that supplies fuel to the combustion chamber and a second fuel supply section that supplies fuel to the combustion chamber through the heat exchanging section. The control unit may control supply of fuel by the first fuel supply section, supply of fuel by the second fuel supply section, combustion of fuel in the combustion chamber, and supply of air by the air supply section, perform supply of air by the air supply section while combusting fuel supplied by the first fuel supply section in the combustion chamber in a state in which supply of fuel by the second fuel supply section is stopped, and create, in an air atmosphere, a state in which a temperature of the heat exchanging section is greater than or equal to a combustible temperature at which fuel is combustible.

According to the above configuration, supply of air to the vaporizer is performed while fuel supplied by the first fuel supply section is combusted in the combustion chamber in a state in which the second fuel supply section is stopped. With this, in a state in which the interior space of the vaporizer is left in an air atmosphere, i.e., in an oxygen atmosphere, the temperature of the heat exchanging section is controlled to be the combustible temperature. As a result, deposits in the vaporizer are allowed to be combusted. Thus, accumulation of deposits in the vaporizer is restrained.

In the burner, preferably, the heating section includes a first heating section that heats fuel supplied by the first fuel supply section and a second heating section that heats fuel supplied by the second fuel supply section. The first heating section is an electric heater. The second heating section is the heat exchanging section. The vaporizer includes a first vaporizer including the electric heater and a second vaporizer including the heat exchanging section. The air supply section includes a first air supply section that supplies air to the first vaporizer and a second air supply section that supplies air to the second vaporizer. The control unit controls supply of electric power to the electric heater, performs supply of air by the second air supply section while combusting vaporized fuel vaporized by the electric heater in the combustion chamber in a state in which supply of fuel by the second fuel supply section is stopped, creates, in an air atmosphere, a state in which the temperature of the heat exchanging section is greater than or equal to the combustible temperature, at which fuel is combustible, subsequently performs supply of air by the first air supply section while continuing supply of electric power to the electric heater in a state in which supply of fuel by the first fuel supply section is stopped, and creates, in an air atmosphere, a state in which the temperature of the electric heater is greater than or equal to the combustible temperature, at which fuel is combustible.

According to the above configuration, after deposits in the second vaporizer are combusted, subsequently, the temperature of the electric heater is controlled to be the combustible temperature in a state in which the interior space of the first vaporizer is left in an air atmosphere, i.e., in an oxygen atmosphere. This allows deposits in the first vaporizer to be combusted. Thus, accumulation of deposits in the first vaporizer is restrained. In addition, combustion heat of vaporized fuel by the electric heater is used for heating of the heat exchanging section. Thus, the temperature of the electric heater has been increased in starting of combustion of deposits in the first vaporizer. As a result, the time required for the temperature of the electric heater to reach the combustible temperature is shortened.

In the burner, the combustion section includes a first tube having a tube end including an ejection port through which combustion gas obtained through combustion of an air-fuel mixture is ejected, a second tube having an open end, which is an opened tube end, and a closed end, which is a closed tube end, wherein the second tube extends from the open end to the ejection port in the first tube, and the closed end is located closer to the ejection port with respect to the open end, and a burner head that connects an inner circumferential face of the first tube with an outer circumferential face of the second tube. The partition member includes the second tube and the burner head. The partition member partitions a space in the first tube into a pre-mixing chamber including a space in the second tube and a combustion chamber that is located outside the second tube and leads to the ejection port. The burner head includes a communication passage that allows an air-fuel mixture in the pre-mixing chamber to pass to the combustion chamber. The heat exchanging section is formed in the second tube. The second tube includes an outer surface that functions as a heat receiving face of the second tube and includes the flow path.

### BRIEF DESCRIPTION OF THE DRAWINGS

FIG. 1 is a schematic diagram illustrating a general arrangement of a burner according to a first embodiment with the engine to which the burner is mounted.

FIG. 2 is a flowchart illustrating one example of a procedure of a pre-combustion process in the first embodiment.

FIG. 3 is a flowchart illustrating one example of a procedure of a post-combustion process in the first embodiment.

FIG. 4 is a schematic view illustrating a general arrangement of a burner according to a second embodiment.

FIG. 5 is a perspective view illustrating a structure of a heat receiving tube and a cover in the second embodiment.

FIG. 6 is a timing chart illustrating one example of the operational manner of the burner according to the second embodiment.

FIG. 7 is a timing chart illustrating one example of the operational manner of a burner in a modification.

### EMBODIMENTS OF THE INVENTION

### First Embodiment

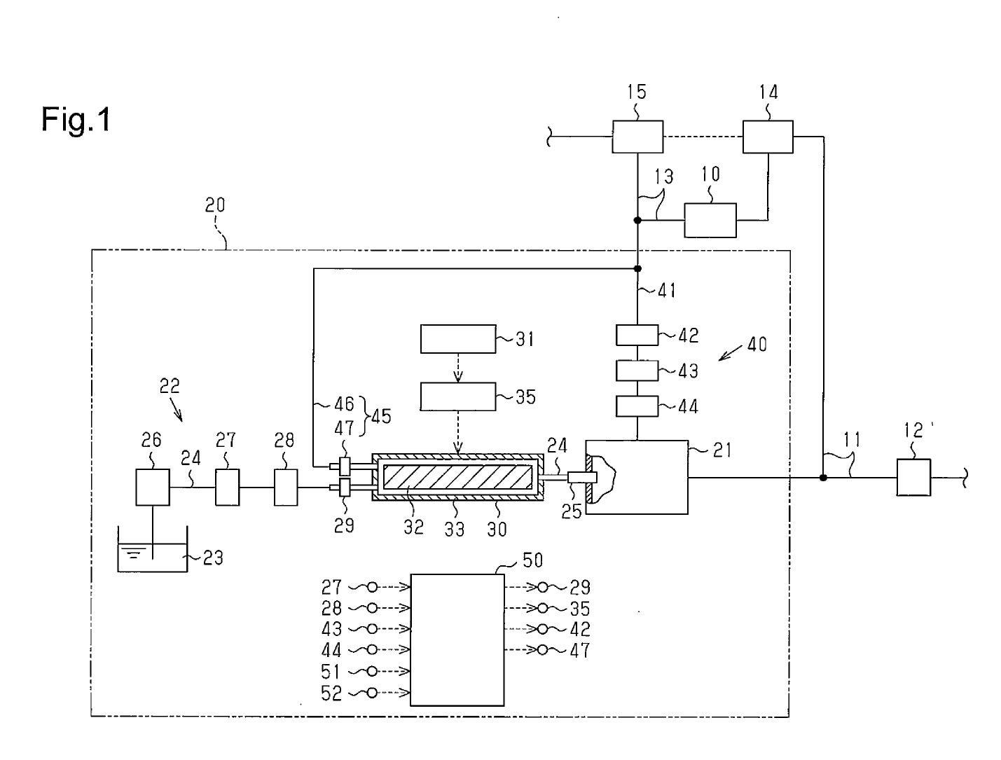

With reference to FIGS. 1 to 3, a burner and a fuel vaporizing device according to a first embodiment will now be described.

As shown in FIG. 1, a diesel particulate filter 12 (hereinafter, referred to as the DPF 12), which adsorbs particulate matter contained in exhaust gas, is mounted to the exhaust passage 11 of a diesel engine 10 (hereinafter, referred to simply as the engine 10). The DPF 12 has, e.g., a honeycomb structure formed of porous silicon carbide. The surfaces of columnar inner walls that constitute the honeycomb structure capture particulate matter in the exhaust gas. A burner 20, which executes a regeneration process of the DPF 12 by increasing the temperature of exhaust gas flowing into the DPF 12, is mounted upstream of the DPF 12.

The burner 20 includes a combustion section 21 that combusts fuel. The combustion section 21 generates a mixture of fuel and air and combusts the generated air-fuel mixture. Thus, the combustion section 21 generates combusted gas, which increases the temperature of exhaust gas flowing into the DPF 12.

A fuel supply section 22 supplies fuel to the combustion section 21. The fuel supply section 22 supplies fuel in a fuel tank 23 through a fuel passage 24 and a supply nozzle 25 to the interior space of the combustion section 21. The fuel supply section 22 is a mechanical pump using the engine 10 as a power source and includes a fuel pump 26 that pumps fuel in the fuel tank 23 toward the combustion section 21 through the fuel passage 24. The fuel pump 26 incorporates a relief valve for causing surplus fuel to flow back to the upstream side of the fuel pump 26 when the discharge pressure exceeds a predetermined pressure. The fuel supply section 22 is located downstream of the fuel pump 26 on the fuel passage 24 and includes a fuel pressure sensor 27 for detecting a fuel pressure Pf, which is the pressure of fuel passing through the fuel passage 24, and a fuel temperature sensor 28 for detecting a fuel temperature Tf, which is the temperature of fuel passing through the fuel passage 24. The fuel supply section 22 is located downstream of the fuel temperature sensor 28 on the fuel passage 24 and includes a fuel valve 29 that opens/closes the fuel passage 24. The fuel supply section 22 supplies fuel to the combustion section 21 when the fuel valve 29 is in the open state. The fuel supply section 22 stops supply of fuel to the combustion section 21 when the fuel valve 29 is in the closed state. A vaporizer 30 is arranged on the fuel passage 24 and located between the fuel valve 29 and the supply nozzle 25. The vaporizer 30 vaporizes fuel to be supplied to the combustion section 21.

The vaporizer 30 includes an electric heater 32 (hereinafter, referred to simply as the heater 32) and a case 33, which accommodates the heater 32. The vaporizer 30 includes a flow path of fuel formed by a gap between the heater 32 and the case 33. The heater 32 is electrically connected to the power supply 31 via a heat regulator 35 and generates heat with electric power supplied from the power supply 31. The power supply 31 is a direct current power source with a predetermined output voltage. The heat regulator 35 converts the direct voltage provided by the power supply 31 into an arbitrary direct voltage and outputs the voltage to the heater 32.

A combustion air supply section 40, which supplies air to the combustion section 21, includes a combustion air passage 41. The downstream end of the combustion air passage 41 is connected to the combustion section 21. The upstream end of the combustion air passage 41 is connected to the intake passage 13 of the engine 10, in particular, a portion of the intake passage 13 that is located downstream of a compressor 15. The compressor 15 rotates with a turbine 14, which is arranged on the exhaust passage 11. The combustion air supply section 40 is located on a portion of the combustion air passage 41 and includes a combustion air valve 42 capable of changing the flow path cross-sectional area of the combustion air passage 41. The combustion air supply section 40 is located on a portion of the combustion air passage 41 that is located downstream of the combustion air valve 42 and includes an air pressure sensor 43 for detecting an air pressure Pa, which is the pressure of air, and an air temperature sensor 44 for detecting an air temperature Ta, which is the temperature of air. The combustion air supply section 40 supplies some of the air compressed by the compressor 15 to the combustion section 21 when the combustion air valve 42 is in the open state.

The burner 20 includes an air supply section 45 for supplying air to the vaporizer 30. The air supply section 45 includes an air passage 46. The downstream end of the air passage 46 is connected to the vaporizer 30. The upstream end of the air passage 46 is connected to a portion of the combustion air passage 41 that is located upstream of the combustion air valve 42. In other words, the air passage 46 is a passage branched off from a portion of the combustion air passage 41 that is located upstream of the combustion air valve 42. The air supply section 45 includes an air valve 47 that opens/closes the air passage 46. The air supply section 45 supplies some of the air compressed by the compressor 15 to the vaporizer 30 when the air valve 47 is in the open state.

In the burner 20, a control unit 50 controls supply of fuel by the fuel supply section 22, supply of air by the combustion air supply section 40 to the combustion section 21, supply of power to the heater 32, and supply of air by the air supply section 45 to the vaporizer 30. The control unit 50 includes a CPU, a ROM, which stores various types of control programs and various types of data, a RAM, which temporarily stores computation results in various types of computations and various types of data, and the like. Various types of processing are executed with the individual control programs stored in the ROM. Here, an operational manner of the burner 20 will now be described with a regeneration process, which burns particulate matter adhered on the DPF 12, as an example. In the regeneration process, in addition to combustion process for generating combusted gas in the combustion section 21, a pre-combustion process, which is performed in the vaporizer 30 prior to the combustion process, and a post-combustion process, which is performed in the vaporizer 30 after the combustion process is ended, are performed.

The control unit 50 obtains the fuel pressure Pf from the fuel pressure sensor 27, the fuel temperature Tf from the fuel temperature sensor 28, the air pressure Pa from the air pressure sensor 43, and the air temperature Ta from the air temperature sensor 44. The control unit 50 further obtains a temperature detected value Th, which indicates the temperature of the heater 32 based on a detection signal from a sensor 51 for detecting the temperature of the heater 32. The sensor 51 may be a temperature sensor for directly measuring the temperature of the heater 32 or a current sensor for detecting a current value supplied to the heater 32.

In addition to these, the control unit 50 obtains various types of information from various types of sensors 52. The information obtained from the sensors 52 includes an upstream exhaust gas flow rate Qe1, which is the flow rate of exhaust gas that exists upstream of the DPF 12, an upstream exhaust gas pressure Pe1, which is the pressure of exhaust gas that exists upstream of the DPF 12, and an upstream exhaust gas temperature Te1, which is the temperature of exhaust gas that exists upstream of the DPF 12. In addition, the information obtained from the sensors 52 includes a DPF temperature Td, which is the temperature of the DPF 12, a downstream exhaust gas pressure Pe2, which is the pressure of exhaust gas that exists downstream of the DPF 12, an intake air amount Qa, which is the amount of air that flows into the compressor 15, and an opening degree A of the combustion air valve 42.

The control unit 50 computes the accumulation amount M of particulate matter in the DPF 12 at a predetermined cycle based on the upstream exhaust gas flow rate Qe1 and the differential pressure ΔP between the upstream exhaust gas pressure Pe1 and the downstream exhaust gas pressure Pe2. The control unit 50 starts the regeneration process of the DPF 12 when the computed accumulation amount M becomes greater than a predetermined threshold α. In other words, the control unit 50 starts the pre-combustion process when the accumulation amount M becomes greater than the threshold α, and the control unit 50 subsequently executes the combustion process after the pre-combustion process is ended. The control unit 50 ends the combustion process and starts the post-combustion process when the accumulation amount M of particulate matter computed during execution of the combustion process becomes less than a predetermined threshold β (β<α). The threshold β is a threshold at which it can be determined that particulate matter accumulated in the DPF 12 has been sufficiently burnt. At the start of the regeneration process, the fuel valve 29, the combustion air valve 42, and the air valve 47 are in the closed states, and supply of electric power to the heater 32 is cut off.

The control unit 50 controls supply of fuel to the combustion section 21 by the fuel supply section 22 by controlling opening/closing of the fuel valve 29.

In the pre-combustion process, the control unit 50 maintains a state in which supply of fuel by the fuel supply section 22 to the combustion section 21 is stopped by maintaining the fuel valve 29 in the closed state.

In the combustion process, the control unit 50 performs supply of fuel by the fuel supply section 22 by controlling opening/closing of the fuel valve 29. The control unit 50 computes a fuel supply amount, which is a mass flow rate of fuel supplied to the combustion section 21 per unit of time, based on, e.g., the upstream exhaust gas flow rate Qe1, the upstream exhaust gas temperature Te1, the DPF temperature Td, and the target temperature of the DPF 12. The fuel supply amount Qf is the amount of fuel necessary for increasing the temperature of DPF 12 to the target temperature by increasing the temperature of exhaust gas flowing into the DPF 12 and is the amount of fuel supplied to the combustion section 21 through the vaporizer 30. The control unit 50 then controls opening/closing of the fuel valve 29 such that the fuel supply amount Qf of fuel is supplied to the vaporizer 30 based on the fuel pressure Pf and the fuel temperature Tf. The control unit 50 controls the fuel valve 29 to be in the closed state and stops supply of fuel by the fuel supply section 22 when the accumulation amount M of particulate matter computed during execution of the combustion process becomes less than the threshold β.

In the post-combustion process, the control unit 50 maintains a state in which supply of fuel by the fuel supply section 22 to the combustion section 21 is stopped by maintaining the fuel valve 29 in the closed state.

The control unit 50 controls supply of electric power to the heater 32 by controlling the output of the heat regulator 35.

In the pre-combustion process, the control unit 50 controls the output of the heat regulator 35 such that the temperature detected value Th is maintained at a combustible temperature Th1, which is a temperature at which a mixture of fuel and air, i.e., deposits and air, is combustible, e.g., around 400° C.

In the combustion process, the control unit 50 controls the output of the heat regulator 35 such that the heater 32 is supplied with electric power sufficient to vaporize the fuel supply amount Qf of fuel based on the fuel supply amount Qf. The control unit 50 continues supply of electric power to the heater 32 even when the accumulation amount M becomes less than the threshold β.

In the post-combustion process, the control unit 50 controls the output of the heat regulator 35 such that the temperature detected value Th is maintained at the combustible temperature Th1. The control unit 50 cuts off supply of electric power to the heater 32 by controlling the output of the heat regulator 35 when a state in which the temperature detected value Th is less than a threshold Th2, which indicates combustion of fuel, has continued for a predetermined period.

The control unit 50 controls supply of air by the combustion air supply section 40 to the combustion section 21 by controlling the opening degree of the combustion air valve 42.

In the pre-combustion process, the control unit 50 maintains a state in which supply of air by the combustion air supply section 40 is stopped by maintaining the combustion air valve 42 in the closed state.

In the combustion process, the control unit 50 performs supply of air to the combustion section 21 by the combustion air supply section 40. The control unit 50 computes, e.g., an amount of air according to the fuel supply amount Qf, i.e., an air supply amount Qs, which is the amount of air required for combusting the fuel supply amount Qf of fuel per unit of time. The control unit 50 controls the opening degree of the combustion air valve 42 such that the air supply amount Qs of air is supplied to the combustion section 21 based on, e.g., the opening degree A of the combustion air valve 42, the air pressure Pa, and the air temperature Ta. The control unit 50 stops supply of air to the combustion section 21 by the combustion air supply section 40 by controlling the combustion air valve 42 to be in the closed state when the accumulation amount M of particulate matter computed during execution of the combustion process becomes less than the threshold β.

In the post-combustion process, the control unit 50 maintains the combustion air valve 42 in the closed state to maintain a state in which supply of air by the combustion air supply section 40 is stopped.

The control unit 50 controls supply of air to the vaporizer 30 by the air supply section 45 by controlling the opening/closing of the air valve 47. In the pre-combustion process and the post-combustion process, the control unit 50 performs air supply operation that controls the air valve 47 such that the air valve 47 is maintained in the closed state after being maintained in the open state for a predetermined period. In the combustion process, the control unit 50 controls the air valve 47 to be in the closed state to stop supply of air to the vaporizer 30 by the air supply section 45. The fuel vaporizing device includes the fuel supply section 22, the vaporizer 30, the heat regulator 35, the air supply section 45, and the control unit 50.

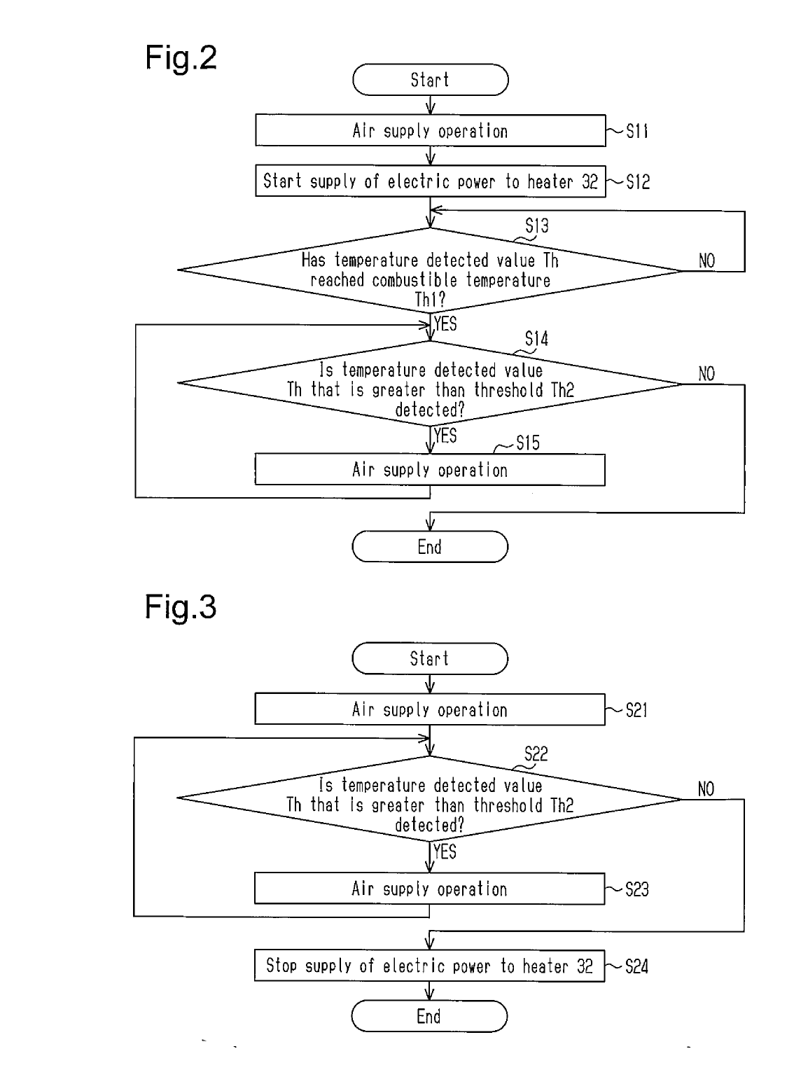

Referring to FIG. 2, one example of the procedure of the pre-combustion process, which is performed prior to the combustion process, will be described.

As shown in FIG. 2, the control unit 50 performs the air supply operation at the first step S11. The control unit 50 then starts supply of electric power to the heater 32 (step S12). After that, the control unit 50 controls the output of the heat regulator 35 to maintain the temperature detected value Th at the combustible temperature Th1.

At the next step S13, the control unit 50 determines whether the temperature detected value Th has reached the combustible temperature Th1 (step S13). When the temperature detected value Th has not reached the combustible temperature Th1 (step S13: NO), the control unit 50 repeatedly executes the processing at step S13 until the temperature detected value Th reaches the combustible temperature Th1.

Alternatively, when the temperature detected value Th has reached the combustible temperature Th1 (step S13: YES), the control unit 50 executes the processing at step S14. At step S14, the control unit 50 determines whether the temperature detected value Th that is greater than the threshold Th2 is detected during a predetermined period after moving to step S14. In other words, the control unit 50 determines whether combustion has occurred in the vaporizer 30.

When the temperature detected value Th that is greater than the threshold Th2 is detected during the predetermined period (step S14: YES), the control unit 50 moves to the processing at step S14 again after performing the air supply operation (step S15).

Alternatively, when the temperature detected value Th that is greater than the threshold Th2 is not detected during the predetermined period (step S14: NO), the control unit 50 ends the pre-combustion process while maintaining supply of electric power to the heater 32.

After the control unit 50 ends the pre-combustion process, the control unit 50 executes the combustion process. After the control unit 50 ends the combustion process, the control unit 50 subsequently performs the post-combustion process.

Referring to FIG. 3, one example of the procedure of the post-combustion process will be described. At the start of the post-combustion process, the heater 32 is supplied with electric power from the power supply 31 continuously after the combustion process.

As shown in FIG. 3, the control unit 50 performs the air supply operation at the first step S21. At the next step S22, the control unit 50 determines whether the temperature detected value Th that is greater than the threshold Th2 is detected during a predetermined period after moving to step S22. In other words, the control unit 50 determines whether fuel has been combusted in the interior space of the vaporizer 30.

When the temperature detected value Th that is greater than the threshold Th2 is detected during the predetermined period (step S22: YES), the control unit 50 moves to the processing at step S22 again after performing the air supply operation (step S23).

Alternatively, when the temperature detected value Th that is greater than the threshold Th2 is not detected during the predetermined period (step S22: NO), the control unit 50 controls the output of the heat regulator 35 to cut off supply of electric power to the heater 32 (step S24) and ends the post-combustion process. With this, the regeneration process is ended.

Operation of the burner 20, which is configured as above, will now be described.

In the above-illustrated burner 20, in the pre-combustion process and the post-combustion process, the supply of air to the vaporizer 30 and supply of electric power to the heater 32 are performed in a state in which supply of fuel to the combustion section 21 is stopped. With this, while the interior space of the vaporizer 30 is left in an oxygen atmosphere, the temperature of the heater 32 is controlled to be the combustible temperature Th1. This allows deposits that exist in the interior space of the vaporizer 30 to be combusted. Thus, accumulation of deposits is restrained in the vaporizer 30.

In addition, the supply of air to the vaporizer 30 allows fuel that remains in the interior space of the vaporizer 30 and a portion of the fuel passage 24 that is located downstream of the vaporizer 30 to be discharged to the combustion section 21 through the supply nozzle 25. This restrains accumulation of deposits in the vaporizer 30 while restraining accumulation of deposits in a portion of the fuel passage 24 that is located between the vaporizer 30 and the supply nozzle 25.

According to the first embodiment, the effects (advantages) listed below are achieved.

(1) Accumulation of deposits is restrained in the vaporizer 30.

(2) Accumulation of deposits is restrained in the fuel passage 24, which connects the vaporizer 30 with the supply nozzle 25.

(3) Since the combustion section 21 communicates with the exhaust passage 11, it is preferable for the pressure of air supplied to the vaporizer 30 to be high. In this regard, the air passage 46 of the air supply section 45 leads to a portion of the intake passage 13 that is located downstream of the compressor 15. In other words, the vaporizer 30 is supplied with air pressured by the compressor 15. As a result, the configuration to increase the pressure of air supplied to the vaporizer 30 is simplified.

(4) The air passage 46 is a passage branched off from the combustion air passage 41. Thus, the configuration to supply air flowing in the intake passage 13 to both the vaporizer 30 and the combustion section 21 is simplified.

(5) The post-combustion process is performed subsequent to the combustion process. This allows the fuel that remains in the vaporizer 30 to be combusted before the fuel deteriorates. As a result, generation of deposits itself is restrained.

(6) The pre-combustion process is performed prior to the combustion process. Thus, it is possible to start supply of fuel by the fuel supply section 22 after deposits that have not been combusted in the previous regeneration process and foreign matter that has been mixed into the vaporizer 30 during the period from the previous regeneration process to the current regeneration process are removed. As a result, vaporization of fuel by the heater 32 is efficiently performed.

(7) In the pre-combustion process, supply of electric power to the heater 32 is started after the air supply operation is performed. In other words, raising the temperature of the heater 32 is started after a portion of the fuel in the interior space of the vaporizer 30 that can be discharged to the combustion section 21 is discharged to the combustion section 21. Thus, heat taken by fuel that remains in the vaporizer 30 is decreased. This shortens the time required for the temperature detected value Th to reach the combustible temperature Th1.

(8) The air supply operation is performed before supply of electric power to the heater 32 is started. After that, the vaporizer 30 is supplied with no new air until the temperature detected value Th reaches the combustible temperature Th1. As a result, the time required for the temperature detected value Th to reach the combustible temperature Th1 is further shortened.

(9) When the temperature detected value Th that is greater than the threshold Th2 is detected, a new air supply operation is performed. With this, new oxygen is supplied to the vaporizer 30. Thus, fuel that remains in the vaporizer 30 is easily combusted.

The above-illustrated first embodiment may be modified in the following forms.

In the regeneration process, only the pre-combustion process may be performed, or only the post-combustion process may be performed so that the control unit 50 supplies air to the vaporizer 30 in a state in which supply of fuel is stopped while controlling the temperature of the heater 32 to be the combustible temperature Th1.

The control unit 50 may perform a process similar to the pre-combustion process between regeneration processes. Even with such a configuration, deposits that exist in the interior space of the vaporizer 30 can be combusted.

The air passage 46 is not limited to a passage branched off from the combustion air passage 41. For example, the air passage 46 may be a passage that connects the vaporizer 30 with the intake passage 13.

To supply air to the vaporizer 30, the air passage 46 may be connected to a portion of the fuel passage 24 that is located between the fuel valve 29 and the vaporizer 30.

The air supplied to the vaporizer 30 is not limited to air flowing in the intake passage 13. The air supplied to the vaporizer 30 may be air stored in an air tank for brakes or air supplied by a blower installed for the burner.

The above-illustrated embodiment may be modified as long as a state is created in which the temperature of the heater 32 in an oxygen atmosphere is greater than or equal to the combustible temperature. Thus, the air supply section 45 may continue to supply air to the vaporizer 30, e.g., in a state in which supply of fuel is stopped.

The burner 20 is not limited to the regeneration process of the DPF 12. For example, the burner 20 may execute a catalyst temperature raising process of increasing the temperature of exhaust gas to increase the temperature of a catalyst for purifying exhaust gas. Then, in the catalyst temperature raising process, at least one of the pre-combustion process and the post-combustion process may be executed.

### Second Embodiment

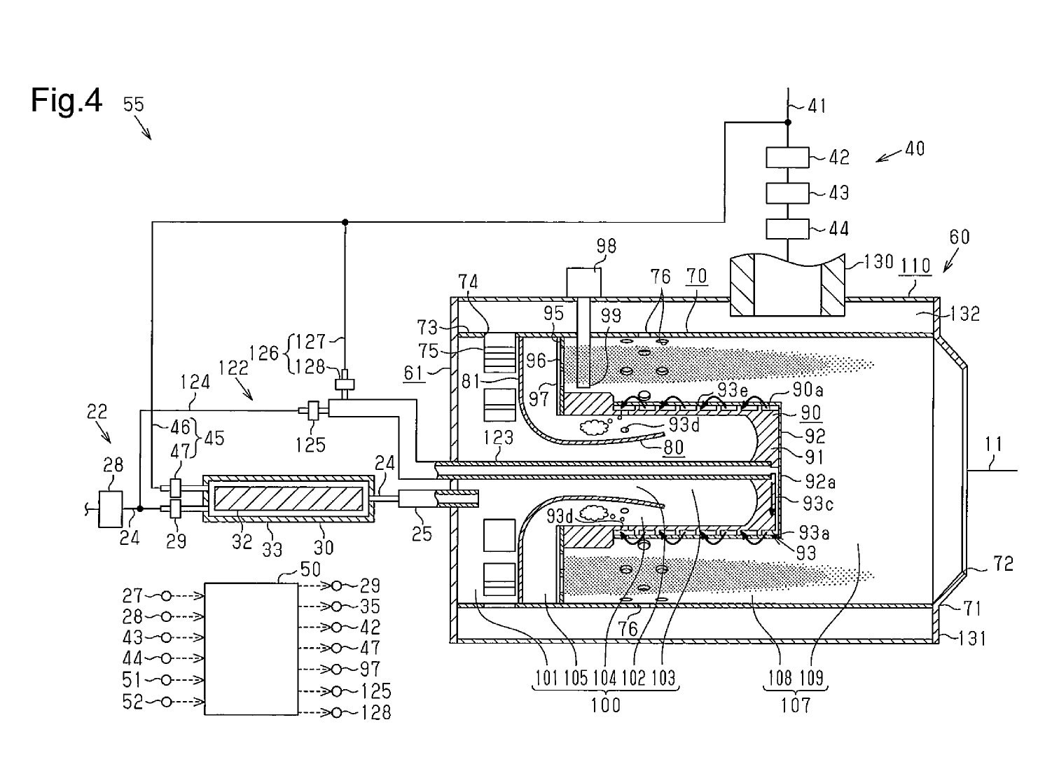

With reference to FIGS. 4 to 6, a burner and a fuel vaporizing device according to a second embodiment will now be described. In the second embodiment, parts different from the first embodiment will be described in detail. The detailed description of parts similar to those of the first embodiment will be omitted by giving like reference numerals. In the second embodiment, the fuel supply section 22, the fuel valve 29, the vaporizer 30, the air supply section 45, the air passage 46, and the air valve 47, which are described in the first embodiment, are referred to as a first fuel supply section 22, a first fuel valve 29, a first vaporizer 30, a first air supply section 45, a first air passage 46, and a first air valve 47, respectively. In addition, the heater 32 functions as a first heating section.

As shown in FIG. 4, the burner 55 according to the second embodiment includes a second fuel supply section 122 in addition to the first fuel supply section 22, which vaporizes fuel by the heater 32. The second fuel supply section 122 vaporizes fuel using combustion heat of fuel in the combustion section 60.

A combustion section 60 of the burner 55 according to the second embodiment will now be described.

A cylindrical inner tube 70, which is one example of a first tube, is fixed to a base 61 of the combustion section 60. A tube end of the inner tube 70 that is a basal end is closed by the base 61. An annular ejection plate 71 is fixed to the distal portion of the inner tube 70. The inner edge of the ejection plate 71 defines an ejection port 72.

A cylindrical tube 80 is located inside the inner tube 70. The inner face of the inner tube 70 and the outer face of the tube 80 are coupled to each other by an annular coupling wall 81, which is continuous with the tube 80. The outer circumferential edge of the coupling wall 81 is fixed to a portion of the inner tube 70 that is closer to the base 61. With this, the coupling wall 81 closes a gap between the inner face of the inner tube 70 and the outer face of the tube 80. The coupling wall 81 has a shape to approach the ejection port 72 as approaching the tube 80. The tube 80 extends toward the ejection port 72 from a portion coupled to the coupling wall 81. The tube end of the tube 80 that is close to the ejection port 72 is open. The inner diameter of the tube 80 gradually increases toward the ejection port 72 so that fuel adhered to the inner face of the tube 80 is easily discharged toward the ejection port 72.

The inner tube 70 includes an extending portion 73, which extends toward the base 61 from a portion of the inner tube 70 that is coupled to the coupling wall 81. The extending portion 73 includes first air introducing ports 74, which are formed at predetermined intervals in the circumferential direction. The first air introducing ports 74 introduce air for combustion into a mixing chamber 101, which is a space surrounded by the extending portion 73. The extending portion 73 includes cutouts 75 each of which is formed by cutting a part of the circumferential wall of the extending portion 73 and raising the part inward from the opening edge of each first air introducing port 74. The cutouts 75 produce a swirling flow, which swirls around the central axis of the inner tube 70, in the mixing chamber 101. The air introduced to the mixing chamber 101 flows into the mixing chamber 102, which is configured with a space inside the tube 80 that is located closer to the ejection port 72. The inner tube 70 includes second air introducing ports 76 for introducing air for combustion into the inner tube 70. Each of the second air introducing ports 76 is located closer to the ejection port 72 from an ignition portion 99.

A heat receiving tube 90, which constitutes a second tube, is located inside the inner tube 70. The heat receiving tube 90 includes an open end, which is a tube end that opens. The tube 80 is inserted in the heat receiving tube 90 through the open end. The heat receiving tube 90 includes a closing portion 91. Of the two tube ends included in the heat receiving tube 90, the tube end that is located closer to the ejection port 72 than the tube 80 is the closed end that is closed by the closing portion 91. In other words, the closing portion 91 constitutes the closed end of the second tube. Mixing chambers 102, 103, and 104 are formed inside the heat receiving tube 90. The mixing chambers 102, 103, and 104 are continuous with a mixing chamber 101, which is surrounded by the extending portion 73 and located closer to the base 61 than the coupling wall 81. The open end of the heat receiving tube 90 is fixed to an annular burner head 95, which connects the inner circumferential face of the inner tube 70 with the outer circumferential face of the heat receiving tube 90.

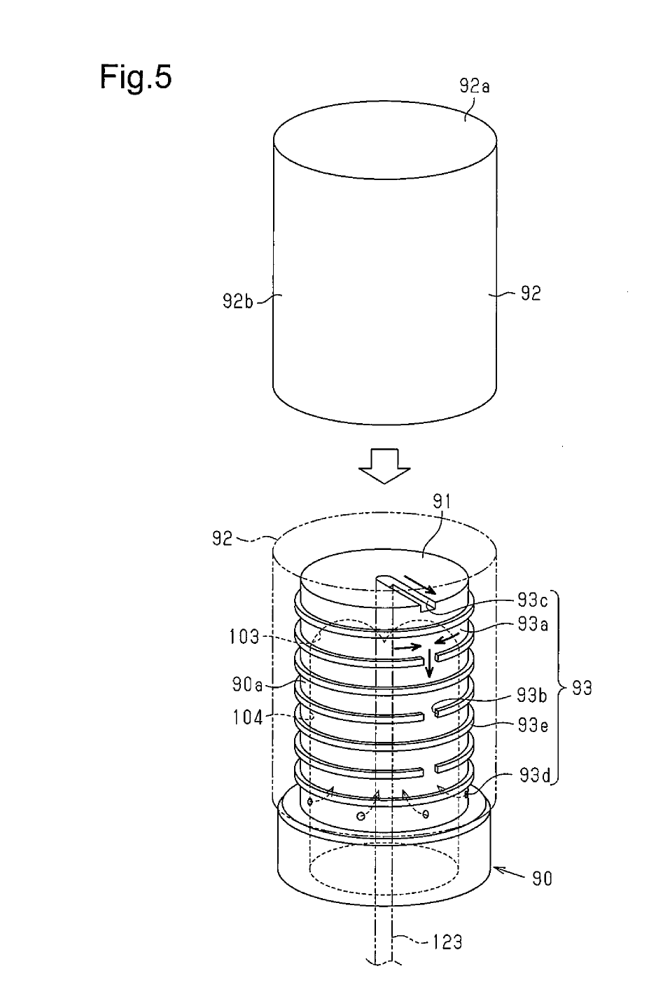

As shown in FIG. 5, the outer circumferential face of the heat receiving tube 90 is covered with a cover 92, which constitutes the second tube. The second tube includes the heat receiving tube 90 and the cover 92. The heat receiving tube 90 and the cover 92 are formed of a metal material such as SUS310, which is excellent in heat resistance to be capable of functioning as a burner and further excellent in thermal conductivity. The outer circumferential face of the heat receiving tube 90 and the cover 92 constitutes a heat exchanging section 93, which converts the combustion heat of the first combustion chamber 108 into vaporization heat of liquid fuel. The second tube, which includes the heat receiving tube 90 and the cover 92, functions as a second vaporizer. The heat exchanging section 93 functions as a second heating section.

The outer circumferential face 90a of the heat receiving tube 90 includes grooves 93a, which are formed parallel with each other, in the circumferential direction. The grooves 93a, which are parallel with each other, are coupled to each other by coupling grooves 93b. The grooves 93a and the coupling grooves 93b constitute a groove, which is continuous across from the closed end to the open end of the second tube.

An inflow groove 93c, which radially extends from the center of the heat receiving tube 90 and is connected to the grooves 93a, is formed on the distal surface that faces the closing portion 91 of the outer surface of the heat receiving tube 90. One end of the inflow groove 93c is connected to a liquid fuel supply passage 123. The liquid fuel supply passage 123 extends in the mixing chambers 102 and 103, which are parts of the interior space of the heat receiving tube 90, in the central axial direction of the heat receiving tube 90. The other end of the inflow groove 93c is connected to one of the grooves 93a that is located at the most distal end.

Furthermore, one of the grooves 93a that is located at the most basal end on the outer circumferential face 90a of the heat receiving tube 90 includes outlets 93d, which pass through the outer circumferential wall of the heat receiving tube 90 in the thickness direction. In other words, the open end of the heat receiving tube 90 is one example of an outflow end of the second tube. The outlets 93d allow the interior of the heat exchanging section 93 to communicate with the mixing chamber 104 in the heat receiving tube 90. The outlets 93d are configured to be arranged, e.g., at equal intervals in the circumferential direction of the outer circumferential face 90a and to cause vaporized fuel to flow out evenly in the circumferential direction of the mixing chamber 102. Understandably, the intervals of the outlets 93d and the number of outlets 93d are not limited to this.

A cover 92, which has a tubular shape with a bottom, is fitted to the heat receiving tube 90 as described above. The cover 92 covers the outer circumferential face 90a of the heat receiving tube 90 with the cylindrical circumferential wall, and a bottom wall 92a, which is a distal wall of the cover 92, constitutes the closed end of the second tube to cover the closing portion 91 of the heat receiving tube 90. When the cover 92 is fitted to the heat receiving tube 90, the inner face of a cylindrical circumferential wall 92b is in contact with the outer ends of the groove walls 93e, which constitute the grooves 93a to form a flow path of liquid fuel between the heat receiving tube 90 and the cover 92. The bottom wall 92a of the cover 92 closes the inflow groove 93c and constitutes an inflow path to the grooves 93a. In other words, the closed end of the heat receiving tube 90 and the distal wall of the cover 92 are one example of an inflow end in the second tube. A flow path closed by the grooves 93a and the coupling grooves 93b is formed between the inflow groove 93c and the outlets 93d.

In the heat exchanging section 93 configured as described above, when a flame is generated in the first combustion chamber 108, the outer surface of the cover 92 functions as a heat receiving face. The combustion heat in the first combustion chamber 108 heats the cover 92 and the heat receiving tube 90. Meanwhile, liquid fuel is supplied to the grooves 93a from the liquid fuel supply passage 123 via the inflow groove 93c. As indicated by arrows in FIG. 5, the liquid fuel flows toward the outlets 93d while streaming along the grooves 93a and the coupling grooves 93b in order from the inflow groove 93c. In this process, the heat exchanging section 93 converts the combustion heat of the first combustion chamber 108 into vaporization heat of liquid fuel to change liquid fuel to vaporized fuel. This causes the vaporized fuel to flow out from the outlets 93d to the mixing chamber 104 inside the heat receiving tube 90. The liquid fuel flowing in the grooves 93a directly contacts the constituent surfaces of the grooves 93a and the inner face of the cover 92. This increases the heat exchanging efficiency.

As shown in FIG. 4, the inner circumferential edge of the burner head 95 is coupled to the heat receiving tube 90 over the entire circumference of the outer circumferential face 90a of the heat receiving tube 90. The outer circumferential edge of the burner head 95 is coupled to the inner tube 70 over the entire circumference of the inner face of the inner tube 70. The burner head 95, the heat receiving tube 90, and the cover 92 are partition members that partition the interior space of the inner tube 70 into two spaces. One of the two spaces is a combustion chamber 107, which is a space that is bordered by the burner head 95 and the heat receiving tube 90 and is closer to the ejection port 72. The other one of the two spaces is a premixing chamber 100, which is a space that is bordered by the burner head 95 and the heat receiving tube 90 and is closer to the base 61. The burner head 95 includes communication passages 96, which allow the combustion chamber 107 to communicate with the premixing chamber 100. A metal mesh 97, which covers the communication passages 96, is attached to the face of the burner head 95 that is closer to the mixing chamber 105.

The ignition portion 99 of an ignition plug 98 is located in a portion that is closer to the ejection port 72 from the burner head 95. The ignition plug 98 is fixed to a cylindrical outer tube 110, into which the heat receiving tube 90 is inserted. The ignition portion 99 is located in the inner tube 70 through through-holes formed in the outer tube 110 and the inner tube 70.

The burner 55 includes a mixing chamber 103 that is located closer to the ejection port 72 than the tube 80. The mixing chamber 103 is a space surrounded by the heat receiving tube 90 and the closing portion 91 and communicates with the mixing chamber 102. Furthermore, a mixing chamber 104, which communicates with the mixing chamber 103, is formed in a gap between the tube 80 and the heat receiving tube 90. Vaporized fuel vaporized in the heat exchanging section 93 flows into the mixing chamber 104 through the outlets 93d. Furthermore, a mixing chamber 105, which is continuous with the mixing chamber 104, is formed between the coupling wall 81 and the burner head 95. The premixing chamber 100 is formed with these mixing chambers 101, 102, 103, 104, and 105.

The burner 55 includes a first combustion chamber 108, which is a gap between the inner tube 70 and the heat receiving tube 90, and a second combustion chamber 109, which is a portion of the space surrounded by the inner tube 70 that is located closer to the ejection port 72 than the closing portion 91. The combustion chamber 107 is formed with the first combustion chamber 108 and second combustion chamber 109.

The burner 55 includes the first fuel supply section 22, which supplies fuel to the mixing chamber 101, and the second fuel supply section 122, which supplies fuel to the mixing chamber 104. The supply nozzle 25 of the first fuel supply section 22 and the liquid fuel supply passage 123 of the second fuel supply section 122 are fixed to a central portion of the base 61.

The distal end of the supply nozzle 25 of the first fuel supply section 22 is located in the mixing chamber 101. The liquid fuel supplied by the first fuel supply section 22 is vaporized in the first vaporizer 30. The vaporized fuel supplied from the supply nozzle 25 to the mixing chamber 101 is mixed with air for combustion that flows into the mixing chamber 101 through the first air introducing ports 74 to generate an air-fuel mixture. After flowing in the mixing chamber 102 toward the ejection port 72, the air-fuel mixture is turned in the mixing chamber 103 and flows in the mixing chamber 104 in a direction opposite to the flow in the mixing chamber 102. After that, the air-fuel mixture is turned again in the mixing chamber 105 and then flows into the combustion chamber 107 through the communication passages 96 of the burner head 95.

The second fuel supply section 122 includes a branch passage 124, which is branched off from a portion of the fuel passage 24 that is located between the fuel temperature sensor 28 and the fuel valve 29. The branch passage 124 connects the fuel passage 24 with the liquid fuel supply passage 123. The liquid fuel supply passage 123 passes through the mixing chambers 101, 102, and 103, extends to the center of the closing portion 91, and is connected to the inflow groove 93c. A second fuel valve 125, which opens/closes the branch passage 124, is arranged in the branch passage 124. The second fuel valve 125 is a normally-closed solenoid valve, which opens/closes a branch passage 124 by duty cycle control. The second fuel supply section 122 supplies liquid fuel that has passed through the second fuel valve 125 to the heat exchanging section 93 through the liquid fuel supply passage 123. Since the liquid fuel supply passage 123 extends in the central axial direction of the heat receiving tube 90, the liquid fuel also is heated in an upstream portion, which leads to the inflow groove 93c. The liquid fuel then streams out from the inflow groove 93c, which is located at the distal end of the heat exchanging section 93, to the coupling groove 93b via the grooves 93a and flows to the outlets 93d, which are located at the basal end of the heat exchanging section 93. At this time, when the heat exchanging section 93 has been heated by combustion of fuel in the first combustion chamber 108, the liquid fuel is vaporized with combustion heat of fuel between the inflow groove 93c and the outlets 93d. The vaporized fuel generated in the heat exchanging section 93 flows from the outlets 93d into the mixing chamber 104. In the mixing chambers 104 and 105, this vaporized fuel and air for combustion are mixed to generate an air-fuel mixture. After that, the air-fuel mixture is turned in the mixing chamber 105, and then the air-fuel mixture flows into the combustion chamber 107 through the communication passages 96 of the burner head 95.

The air-fuel mixture that has flowed into the combustion chamber 107 is ignited by the ignition portion 99. This generates a flame, which is the air-fuel mixture during combustion, combusted gas, which is the air-fuel mixture after combustion, and combustion reaction gas, which includes the flame and the combusted gas, in the combustion chamber 107. The heat receiving tube 90 and the cover 92 are heated with the combustion reaction gas that flows toward the ejection port 72 and heats fuel flowing in the heat exchanging section 93 and an air-fuel mixture in the mixing chambers 103 and 104.

The outer tube 110, into which the inner tube 70 is inserted, is fixed to the base 61 of the burner 55. Of the two tube ends of the outer tube 110, the basal end is closed by the base 61. An annular closing plate 131 is arranged at the distal end of the outer tube 110, and the closing plate 131 closes a gap between the outer tube 110 and the heat receiving tube 90.

The end of the outer tube 110 that is closer to the ejection port 72 is connected to a downstream end of the combustion air passage 41. Some of the intake air flowing in the intake passage 13 flows, as air for combustion, into the air flow chamber 132, which is a gap between the inner tube 70 and the outer tube 110, through the combustion air passage 41 when the combustion air valve 42 is in the open state. The air for combustion is supplied to the combustion chamber 107 through the second air introducing ports 76 and introduced to the mixing chamber 101 through the first air introducing ports 74.

The burner 55 includes a second air supply section 126 for supplying air to the liquid fuel supply passage 123. The second air supply section 126 includes a second air passage 127, which is branched off from the first air passage 46, and a second air valve 128 for opening/closing the second air passage 127. The second air valve 128 is a normally-closed solenoid valve, which opens/closes the second air passage 127 by duty cycle control. The second air supply section 126 supplies some of the air compressed by a compressor to the liquid fuel supply passage 123 when the second air valve 128 is in the open state.

Supply of fuel by the first fuel supply section 22, supply of electric power to the heater 32, supply of air by the combustion air supply section 40 to the combustion section 60, supply of air by the first air supply section 45 to the first vaporizer 30, and driving of the ignition plug 98, which are described above, are controlled by the control unit 50. In addition, supply of fuel by the second fuel supply section 122 and supply of air by the second air supply section 126 to the liquid fuel supply passage 123 are controlled by the control unit 50.

In the second embodiment, the control unit 50 supplies electric power to the heater 32 such that the temperature detected value Th is maintained at the vaporization temperature Th3, which is a temperature at which fuel can be vaporized and which is greater than or equal to the combustible temperature Th1. Thus, a maximum vaporization amount Qf1, which is the maximum amount of fuel that can be vaporized per unit of time, is set to the first vaporizer 30.

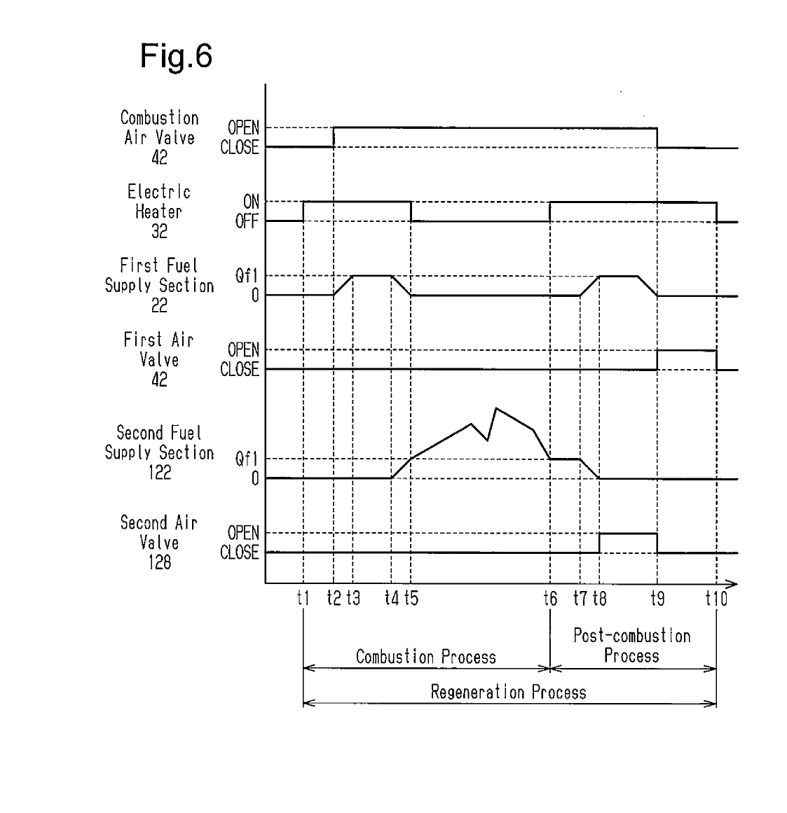

Referring to FIG. 6, the operational manner of the burner 55 will be described with the regeneration process of the DPF as an example. As shown in FIG. 6, in the regeneration process, in addition to the combustion process, which burns particulate matter that is adhered to the DPF 12, a post-combustion process, which is performed after the completion of the combustion process, is performed.

The control unit 50 starts the regeneration process of the DPF 12 when the accumulation amount M, which is based on the differential pressure ΔP between the upstream exhaust gas pressure Pe1 and the downstream exhaust gas pressure Pe2 and the upstream exhaust gas flow rate Qe1, becomes greater than the threshold α. In other words, the control unit 50 starts the combustion process. The control unit 50 ends the combustion process and starts the post-combustion process when the accumulation amount M of the particulate matter, which is computed during the combustion process, becomes less than the threshold β (β<α). The threshold β is a predetermined threshold and a threshold at which it can be determined that particulate matter accumulated in the DPF 12 is sufficiently burnt. At the start of the regeneration process, the first fuel valve 29, the combustion air valve 42, the first air valve 47, the second fuel valve 125, and the second air valve 128 are in the closed states, and supply of electric power to the heater 32 is cut off.

In the combustion process, the control unit 50 starts supply of electric power to the heater 32 at start time t1 of the regeneration process. The control unit 50 starts supply of fuel by the first fuel supply section 22 by controlling opening/closing of the first fuel valve 29 at time t2 at which the temperature detected value Th has reached the vaporization temperature Th3. This supplies vaporized fuel to the mixing chamber 101 from the supply nozzle 25. The control unit 50 starts supply of air for combustion to the combustion section 60 at time t2 by controlling the opening degree of the combustion air valve 42. The control unit 50 then ignites an air-fuel mixture by controlling the ignition plug 98 to control the burner 55 to be in the combustion state. In FIG. 6, the burner 55 is in the combustion state when the combustion air valve 42 is in the open state, and the burner 55 is in the non-combustion state when the combustion air valve 42 is in the closed state.

The control unit 50 gradually increases the amount of fuel supplied by the first fuel supply section 22 based on the fuel pressure Pf and the fuel temperature Tf. At time t3, the control unit 50 supplies the maximum vaporization amount Qf1 of fuel to the first vaporizer 30. The control unit 50 supplies the air supply amount Qs corresponding to the amount of fuel supplied by the first fuel supply section 22 by controlling the combustion air valve 42 based on the opening degree A of the combustion air valve 42, the air pressure Pa, and the air temperature Ta. At time t4, supply of fuel of an amount that allows vaporization of fuel in the heat exchanging section 93 from the first fuel supply section 22 is finished. The control unit 50 starts supply of fuel by the second fuel supply section 122 at time t4. The time t4 may be determined based on the detected value by the temperature sensor, which is attached to the heat receiving tube 90.

During the period from time t4 to the next time t5, the control unit 50 supplies the maximum vaporization amount Qf1 of fuel to the combustion section 60 by controlling opening/closing of the first and second fuel valves 29 and 125 while continuing supply of electric power to the heater 32. At this time, the control unit 50 supplies the maximum vaporization amount Qf1 of fuel to the combustion section 60 while decreasing the fuel supply amount by the first fuel supply section 22 and increasing the fuel supply amount by the second fuel supply section 122 as time passes. Fuel supplied by the second fuel supply section 122 flows into the mixing chamber 104 as vaporized fuel after being vaporized in the heat exchanging section 93. At time t5, the control unit 50 then controls the first fuel valve 29 to be in the closed state and cuts off supply of electric power to the heater 32. At this time, the burner 55 maintains the combustion state with supply of fuel by the second fuel supply section 122.

Subsequently, the control unit 50 computes the fuel supply amount Qf and computes the air supply amount Qs. The control unit 50 controls opening/closing of the second fuel valve 125 such that the fuel supply amount Qf of fuel is supplied to the combustion section 60. At the same time, the control unit 50 controls opening/closing of the combustion air valve 42 such that the air supply amount Qs of air is supplied to the combustion section 60. At this time, fuel supplied by the second fuel supply section 122 flows into the mixing chamber 104 as vaporized fuel after being vaporized in the heat exchanging section 93 and is finally combusted in the combustion chamber 107.

In the heat exchanging section 93, in which fuel is vaporized in this way, deposits are generated due to deterioration of a constituent yet to be vaporized during vaporization of fuel. Thus, it is preferable that accumulation of deposits be restrained not only in the first vaporizer 30 but also in the heat exchanging section 93. At time t6, when the accumulation amount M of particulate matter, which is computed during execution of the combustion process, becomes less than the threshold β, the control unit 50 ends the combustion process and subsequently executes the post-combustion process. The post-combustion process is a process that restrains accumulation of deposits in the first vaporizer 30 and the heat exchanging section 93.

In the post-combustion process, the control unit 50 supplies the maximum vaporization amount Qf1 of fuel to the combustion section 60 from the second fuel supply section 122 and starts supply of electric power to the heater 32. When the temperature detected value Th has reached the vaporization temperature Th3 at the subsequent time t7, the control unit 50 supplies the maximum vaporization amount Qf1 of fuel to the combustion section 60 by controlling opening/closing of the first and second fuel valves 29 and 125 during the period from time t7 to the next time t8, while continuing supply of electric power to the heater 32. At this time, the control unit 50 supplies the maximum vaporization amount Qf1 of fuel to the combustion section 60 while decreasing the fuel supply amount by the second fuel supply section 122 and increasing the fuel supply amount by the first fuel supply section 22 as time passes. At time t8, the control unit 50 controls the second fuel valve 125 to be in the closed state. The control unit 50 then supplies air to the liquid fuel supply passage 123 by controlling the second air valve 128 to be in the open state while maintaining the burner 55 in the combustion state using vaporized fuel by the first fuel supply section 22 and the first vaporizer 30 during the period from time t8 to time t9, at which a predetermined time has passed from time t8.

With the supply of air to the liquid fuel supply passage 123, the fuel that can be discharged to the mixing chamber 104 in the liquid fuel supply passage 123 and the heat exchanging section 93 is discharged to the mixing chamber 104. With this, deposits that are adhered in the heat exchanging section 93 and the fuel that remains in the heat exchanging section 93 are left in the air atmosphere. The heat exchanging section 93 receives combustion heat with fuel having been discharged therefrom. Thus, the temperature of the heat exchanging section 93 increases to a temperature higher than the combustible temperature Th1. In other words, deposits and remaining fuel in the heat exchanging section 93 are left in an atmosphere in which the temperature is higher than the combustible temperature Th1. This allows deposits and remaining fuel in the heat exchanging section 93 to be combusted. Thus, accumulation of deposits is restrained in the heat exchanging section 93.

At time t9, the control unit 50 controls the burner 55 to be in the non-combustion state by controlling the first fuel valve 29 and the combustion air valve 42 to be in the closed states. The control unit 50 then controls the first air valve 47 to be in the open state for the period until time t10, at which a predetermined period has passed, while continuing supply of electric power to the heater 32. With this, deposits that exist in the interior space of the first vaporizer 30 are removed by being combusted in an oxygen atmosphere. Thus, accumulation of deposits is restrained in the first vaporizer 30. The fuel vaporizing device includes the second fuel supply section 122, the heat receiving tube 90 and the cover 92, the heat exchanging section 93, the first fuel supply section 22, the second air supply section 126, and the control unit 50.

According to the second embodiment, effects (advantages) listed below are achieved.

(1) Air is supplied to the heat exchanging section 93 in a state in which supply of fuel by the second fuel supply section 122 is stopped and the burner 55 is controlled to be in the combustion state. With this, deposits and remaining fuel in the heat exchanging section 93 are combusted. As a result, accumulation of deposits is restrained in the heat exchanging section 93.

(2) After deposits and remaining fuel in the heat exchanging section 93 are combusted, subsequently, the first fuel valve is controlled to be in the closed state, and the temperature of the heater 32 is controlled to be greater than or equal to the combustible temperature while air is supplied to the first vaporizer 30. With this, deposits and remaining fuel in the first vaporizer 30 are combusted. Thus, accumulation of deposits in the first vaporizer 30 is restrained. Furthermore, the heat exchanging section 93 is heated utilizing vaporized fuel by the heater 32. Thus, in starting combustion of deposits in the first vaporizer 30, the temperature of the heater 32 has already been increased. As a result, the time required for the temperature of the heater 32 to reach the combustible temperature is shortened.

(3) In the post-combustion process, combustion of deposits and remaining fuel in the heat exchanging section 93 is performed prior to the first vaporizer 30. Thus, the heat exchanging section 93 with the temperature increased with the combustion process is efficiently utilized. As a result, the time required for deposits and remaining fuel in the heat exchanging section 93 to be combusted is shortened.

(4) The second air passage 127 is branched off from the first air passage 46, which leads to the intake passage 13 located downstream of the compressor 15. With this, the heat exchanging section 93 is supplied with air compressed by the compressor 15. As a result, the configuration to increase the pressure of air supplied to the heat exchanging section 93 is simplified.

(5) The first air passage 46 is a passage branched off from the combustion air passage 41. Thus, the configuration to supply air flowing in the intake passage 13 to the first vaporizer 30, the combustion section 60, and the heat exchanging section 93 is simplified.

(6) Subsequent to the combustion process, the post-combustion process is performed. This allows fuel that remains in the heat exchanging section 93 and the first vaporizer 30 to be combusted before deterioration. As a result, generation of deposits itself is restrained.

(7) In a state in which the burner 55 is maintained in the combustion state, air is supplied to the heat exchanging section 93. As a result, decrease in the temperature of the heat exchanging section 93, which is caused by supply of air, is limited. Thus, deposits and remaining fuel in the heat exchanging section 93 are reliably combusted.

(8) When fuel is vaporized only by the heater 32, a large amount of electric power is required depending on the fuel supply amount Qf. In this regard, in the burner 55, when the heat exchanging section 93 is heated, supply of fuel by the second fuel supply section 122 is started, and supply of fuel by the first fuel supply section 22 and supply of electric power to the heater 32 are stopped. As a result, heat of combustion reaction gas is efficiently used, while power consumption in the heater 32 is limited.

The above-illustrated second embodiment may be modified in the following forms.

The second air passage 127 is not limited to a passage branched off from the first air passage 46. The second air passage 127 may be a passage that is directly connected to the combustion air passage 41.

The burner 55 does not necessarily need to include the first vaporizer 30, which vaporizes fuel supplied by the first fuel supply section 22. In other words, the burner 55 may be configured to, e.g., spray liquid fuel supplied by the first fuel supply section 22 to the mixing chamber 101. With such a configuration, the entire configuration of the burner 55 is simplified.

The heat exchanging section 93, which is a heating section, may be modified as long as fuel is vaporized with combustion heat of the combustion chamber 107. For example, the heat exchanging section 93 may be configured such that a flow path contacts the outer circumferential face of the inner tube 70 or such that a flow path passes through the combustion chamber 107.

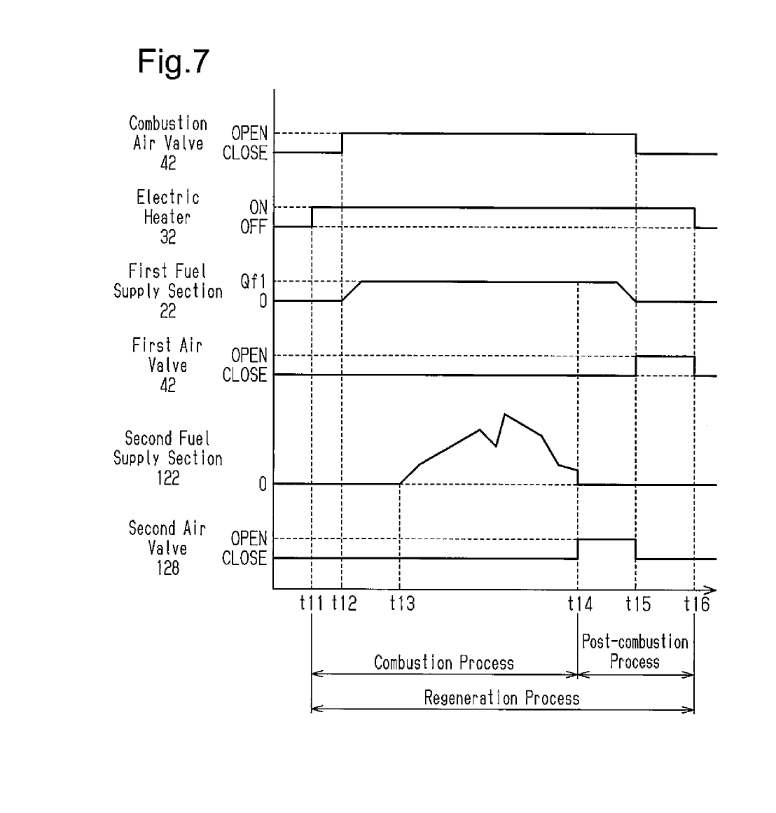

As shown in FIG. 7, supply of electric power to the heater 32 and supply of fuel by the first fuel supply section 22 may be also performed during the combustion process.

In this case, the control unit 50 starts supply of electric power to the heater 32 at start time t11 of the regeneration process. The control unit 50 starts supply of fuel by the first fuel supply section 22 at time t12, at which the temperature detected value Th reaches the vaporization temperature Th3. With this, the mixing chamber 101 is supplied with vaporized fuel from the supply nozzle 25. The control unit 50 starts supply of air for combustion to the combustion section 60 by controlling the opening degree of combustion air valve 42 at time t12. The control unit 50 then ignites an air-fuel mixture by controlling the ignition plug 98 and controls the burner 55 to be in the combustion state. The control unit 50 starts supply of fuel by the second fuel supply section 122 from time t13 at which supply of a predetermined amount of fuel that allows vaporization of fuel in the heat exchanging section 93 from the first fuel supply section 22 is finished.

When starting supply of fuel by the second fuel supply section 122, the control unit 50 computes the fuel supply amount Qf and computes the air supply amount Qs. The control unit 50 supplies fuel with the maximum vaporization amount Qf1 of the fuel supply amount Qf from the first fuel supply section 22 to the combustion section 60 while maintaining supply of electric power to the heater 32, and supplies the reaming amount of fuel from the second fuel supply section 122 to the combustion section 60. The control unit 50 controls opening/closing of the combustion air valve 42 such that the air supply amount Qs of air is supplied to the combustion section 60. In this way, the control unit 50 continuously performs supply of vaporized fuel by the first fuel supply section 22. The control unit 50 then ends the combustion process when the accumulation amount M has become less than the threshold β at time t14. The control unit 50 subsequently executes the post-combustion process.

In the post-combustion process, the control unit 50 maintains the burner 55 in the combustion state by maintaining supply of electric power to the heater 32 and supply of fuel by the first fuel supply section 22. At the same time, the control unit 50 stops supply of fuel by the second fuel supply section 122. The control unit 50 then supplies air to the liquid fuel supply passage 123 by controlling the second air valve 128 to be in the open state for the period from time t14 to the next time t15. With this, deposits and remaining fuel in the heat exchanging section 93 are removed by being combusted in an oxygen atmosphere. Thus, accumulation of deposits in the heat exchanging section 93 is restrained.

At time t15, the control unit 50 controls the burner 55 to be in the non-combustion state by controlling the second air valve 128 to be in the closed state and controlling the first fuel valve 29 and the combustion air valve 42 to be in the closed states. The control unit 50 then controls the first air valve 47 to be in the open state until time t16, at which a predetermined time has passed, while continuing supply of electric power to the heater 32. With this, deposits that exist in the interior space of the first vaporizer 30 are removed by being combusted in an oxygen atmosphere. Thus, accumulation of deposits in the first vaporizer 30 is restrained.

Supply of electric power to the heater 32 is continuously performed in this way, so that the need to increase the temperature of the heater 32 at the start of the post-combustion process is eliminated. As a result, the time required for the post-combustion process is shortened.

Air supplied to the heat exchanging section 93 is not limited to air flowing in the intake passage 13. Air supplied to the heat exchanging section 93 may be air stored in an air tank for brakes or air supplied by a blower installed for the burner.

The control unit 50 may perform a process that supplies air from the second air supply section 126 to the heat exchanging section 93 after controlling the burner 55 to be in the combustion state between regeneration processes. At this time, the control unit 50 first starts supply of electric power to the heater 32 and starts supply of fuel by the first fuel supply section 22 when the temperature detected value Th has reached the combustible temperature Th1. The control unit 50 next controls the burner 55 to be in the combustion state by controlling the combustion air valve 42 to be in the open state and controlling the ignition plug 98. The control unit 50 supplies air to the liquid fuel supply passage 123 by controlling the second air valve 128 to be in the open state when an amount of fuel that allows combustion of fuel in the heat exchanging section 93 is supplied from the first fuel supply section 22. The control unit 50 then controls the first fuel valve 29, the combustion air valve 42, and the second air valve 125 to be in the closed states and cuts off supply of electric power to the heater 32 when the combustion state of the burner 55 and supply of air by the second air supply section 126 continue for a predetermined time. With such a configuration, deposits in the heat exchanging section 93 are also allowed to be combusted.

The burner 55 is not limited to executing the regeneration process of the DPF 12. For example, the burner 55 may execute a catalyst temperature increasing process in which the temperature of exhaust gas is increased to increase the temperature of a catalyst for purifying exhaust gas. In the catalyst temperature increasing process, the aforementioned combustion process and post-combustion process may be executed.

### REFERENCE NUMERALS

10 . . . diesel engine, 11 . . . exhaust passage, 12 . . . diesel particulate filter, 13 . . . intake passage, 14 . . . turbine, 15 . . . compressor, 20 . . . burner, 21 . . . combustion section, 22 . . . fuel supply section, 23 . . . fuel tank, 24 . . . fuel passage, 25 . . . supply nozzle, 26 . . . fuel pump, 27 . . . fuel pressure sensor, 28 . . . fuel temperature sensor, 29 . . . fuel valve, 30 . . . vaporizer, 31 . . . power supply, 32 . . . electric heater, 33 . . . case, 35 . . . heat regulator, 40 . . . combustion air supply section, 41 . . . combustion air passage, 42 . . . combustion air valve, 43 . . . air pressure sensor, 44 . . . air temperature sensor, 45 . . . air supply section, 46 . . . air passage, 47 . . . air valve, 50 . . . control unit, 51,52 . . . sensor, 55 . . . burner, 60 . . . combustion section, 61 . . . base, 70 . . . inner tube, 71 . . . ejection plate, 72 . . . ejection port, 73 . . . extending portion, 74 . . . first air introducing port, 75 . . . cutout, 76 . . . second air introducing port, 80 . . . tube, 81 . . . coupling wall, 90 . . . heat receiving tube, 90a . . . outer circumferential face, 91 . . . closing portion, 92 . . . cover, 92a . . . bottom wall, 92b . . . circumferential wall, 93 . . . heat exchanging section, 93a . . . groove, 93b . . . coupling groove, 93c . . . inflow groove, 93d . . . outlet, 93e . . . groove wall, 95 . . . burner head, 96 . . . communication passage, 97 . . . metal mesh, 98 . . . ignition plug, 99 . . . ignition portion, 100 . . . premixing chamber, 101,102,103,104,105 . . . mixing chamber, 107 . . . combustion chamber, 108 . . . first combustion chamber, 109 . . . second combustion chamber, 110 . . . outer tube, 122 . . . second fuel supply section, 123 . . . liquid fuel supply passage, 124 . . . branch passage, 125 . . . second fuel valve, 126 . . . second air supply section, 127 . . . second air passage, 128 . . . second air valve, 131 . . . closing plate, 132 . . . air flow chamber.

1. A burner comprising:
a combustion section including a combustion chamber in which fuel is combusted;
a fuel supply section that supplies fuel;
a vaporizer that supplies vaporized fuel to the combustion chamber, the vaporized fuel being a fuel vaporized by heating fuel supplied from the fuel supply section with a heating section;
an air supply section that supplies air to the vaporizer; and
a control unit that controls supply of fuel by the fuel supply section, heating of the heating section, and supply of air by the air supply section,
wherein the control unit performs supply of air by the air supply section and heating of the heating section while supply of fuel by the fuel supply section is stopped, and creates, in an air atmosphere, a state in which a temperature of the heating section is greater than or equal to a combustible temperature at which fuel is combustible.

2. The burner according to claim 1, wherein
the air supply section includes:
an air passage that leads to a portion located downstream of a compressor, which constitutes a forced induction device, in an intake passage of an engine; and
an air valve that opens/closes the air passage, and
the control unit supplies air to the vaporizer by controlling the air valve to be in an open state and stops supply of air to the vaporizer by controlling the air valve to be in a closed state.

3. The burner according to claim 2, further comprising a combustion air supply section that supplies air to the combustion section, wherein
the combustion air supply section includes:
a combustion air passage that connects the combustion section with the intake passage; and
a combustion air valve that opens/closes the combustion air passage, and
the air passage is branched off from a portion of the combustion air passage that is located upstream of the combustion air valve.

4. The burner according to claim 1, wherein
the heating section is an electric heater, and
immediately after supply of fuel by the fuel supply section is finished, the control unit creates, in an air atmosphere, a state in which a temperature of the electric heater is greater than or equal to the combustible temperature, at which fuel is combustible.

5. The burner according to claim 1, wherein
the heating section is an electric heater, and
the control unit starts supply of fuel by the fuel supply section after creating, in an air atmosphere, a state in which a temperature of the electric heater is greater than or equal to the combustible temperature, at which fuel is combustible.

6. The burner according to claim 1, wherein
the vaporizer is configured by a partition member that partitions the combustion chamber,
the heating section is a heat exchanging section that vaporizes fuel flowing through a flow path formed by the partition member with combustion heat of the combustion chamber,
the fuel supply section includes:
a first fuel supply section that supplies fuel to the combustion chamber; and
a second fuel supply section that supplies fuel to the combustion chamber through the heat exchanging section, and
the control unit:
controls supply of fuel by the first fuel supply section, supply of fuel by the second fuel supply section, combustion of fuel in the combustion chamber, and supply of air by the air supply section;
performs supply of air by the air supply section while combusting fuel supplied by the first fuel supply section in the combustion chamber in a state in which supply of fuel by the second fuel supply section is stopped; and
creates, in an air atmosphere, a state in which a temperature of the heat exchanging section is greater than or equal to a combustible temperature at which fuel is combustible.

7. The burner according to claim 6, wherein
the heating section includes a first heating section that heats fuel supplied by the first fuel supply section and a second heating section that heats fuel supplied by the second fuel supply section,
the first heating section is an electric heater,
the second heating section is the heat exchanging section,
the vaporizer includes a first vaporizer including the electric heater and a second vaporizer including the heat exchanging section,
the air supply section includes a first air supply section that supplies air to the first vaporizer and a second air supply section that supplies air to the second vaporizer, and
the control unit:
controls supply of electric power to the electric heater;
performs supply of air by the second air supply section while combusting vaporized fuel vaporized by the electric heater in the combustion chamber in a state in which supply of fuel by the second fuel supply section is stopped;
creates, in an air atmosphere, a state in which the temperature of the heat exchanging section is greater than or equal to the combustible temperature, at which fuel is combustible;
subsequently performs supply of air by the first air supply section while continuing supply of electric power to the electric heater in a state in which supply of fuel by the first fuel supply section is stopped; and
creates, in an air atmosphere, a state in which the temperature of the electric heater is greater than or equal to the combustible temperature, at which fuel is combustible.

8. The burner according to claim 6, wherein
the combustion section includes:
a first tube having a tube end including an ejection port through which combustion gas obtained through combustion of an air-fuel mixture is ejected;
a second tube having an open end, which is an opened tube end, and a closed end, which is a closed tube end, wherein the second tube extends from the open end to the ejection port in the first tube, and the closed end is located closer to the ejection port with respect to the open end; and
a burner head that connects an inner circumferential face of the first tube with an outer circumferential face of the second tube,
the partition member includes the second tube and the burner head,
the partition member partitions a space in the first tube into a pre-mixing chamber including a space in the second tube and a combustion chamber that is located outside the second tube and leads to the ejection port,
the burner head includes a communication passage that allows an air-fuel mixture in the pre-mixing chamber to pass to the combustion chamber,
the heat exchanging section is formed in the second tube, and
the second tube includes an outer surface that functions as a heat receiving face of the second tube and includes the flow path.

9. A fuel vaporizing device comprising:
a fuel supply section that supplies fuel to a combustion section including a combustion chamber in which fuel is combusted;
a vaporizer that supplies vaporized fuel to the combustion chamber, the vaporized fuel being a fuel vaporized by heating fuel supplied from the fuel supply section with a heating section;
an air supply section that supplies air to the vaporizer; and
a control unit that controls supply of fuel by the fuel supply section, heating of the heating section, and supply of air by the air supply section,
wherein the control unit performs supply of air by the air supply section and heating of the heating section in a state in which supply of fuel by the fuel supply section is stopped and creates, in an air atmosphere, a state in which a temperature of the heating section is greater than or equal to a combustible temperature at which fuel is combustible.
